(19) United States
(12) Patent Application Publication
(10) Pub. No.: US 2021/0390802 A1
(43) Pub. Date: Dec. 16, 2021

(54) Method, Computer Program And Device For Processing Signals

(71) Applicant: Volkswagen Aktiengesellschaft, Wolfsburg (DE)

(72) Inventors: Andreas Udo Sass, Hannover (DE); Christopher Vox, Braunschweig (DE)

(73) Assignee: Volkswagen Aktiengesellschaft, Wolfsburg (DE)

(21) Appl. No.: 17/346,617

(22) Filed: Jun. 14, 2021

(30) Foreign Application Priority Data
Jun. 16, 2020 (DE) 10 2020 207 449.6

(51) Int. Cl. G07C 5/08; G06K 9/62

(52) U.S. Cl. CPC G07C 5/0816; G06K 9/6277; G06K 9/6218

(57) ABSTRACT

The present invention relates to a method, a computer program having instructions, and a device for processing signals. The invention also relates to a means of conveyance as well as an industrial machine in which a method according to the invention, or device according to the invention, is used. In a first step, the signals are sequenced into sections. Then at least one statistical feature is determined for each of the sections. Subsequently, a feature space of the determined statistical features can optionally be first transformed into a lower dimensional space. The signals are clustered based on the determined statistical features. For each cluster, a signal is then determined as a representative. At least the signals determined as representatives are finally provided for further processing. Alternatively, clusters for identifying a faulty sensor that result from clustering are used.

### CROSS-REFERENCE TO RELATED APPLICATIONS

This application claims priority to German Patent Application No. DE 10 2020 207 449.6, filed on Jun. 16, 2020 with the German Patent and Trademark Office. The contents of the aforesaid Patent Application are incorporated herein for all purposes.

### TECHNICAL FIELD

The present invention relates to a method, a computer program, and a device for processing signals. The invention also relates to a means of conveyance as well as an industrial machine in which a method or device as described herein, is used.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

In contemporary means of conveyance and other machines, generally a plurality of sensors are installed that provide sensor signals relating to a series of components of the means of conveyance, or respectively the machine. In addition to the sensor signals, modeled variables are also exchanged within the vehicles that were not measured, but rather calculated using an internal model. Other occurring signals are manipulated variables that specify a control for actuators installed in the vehicle. These signals can inter alia also be used to make a data-driven age prediction.

With a data-driven prediction, the selection of the considered features plays a decisive role in the quality of the prediction. The better the features, the better the result as well. Transferred to a means of conveyance, this means that the signals should contain as little redundant information as possible so that the best possible prediction can be made. It is therefore recommendable to combine signals into clusters in order to thereby identify and remove redundant information.

However, it has been revealed that merely clustering the time series of the signals frequently does not yield useful results.

### SUMMARY

An object exists to provide solutions for processing signals that enable a reliable determination of clusters of signals which are suitable for data-driven predictions.

The object is solved by a method, by a computer program, and by a device having the features of the independent claims. Embodiments of the invention are discussed in the dependent claims and the following description.

### BRIEF DESCRIPTION OF THE DRAWINGS

FIG. 1 schematically shows an example method for processing signals;

FIG. 2 shows a first embodiment of a device for processing signals;

FIG. 3 shows a second embodiment of a device for processing signals;

FIG. 4 schematically shows a means of conveyance in which an example solution is realized;

FIG. 5 schematically shows a series of signals that are subject to exemplary preprocessing;

FIG. 6 schematically shows the signals from FIG. 5 following the conclusion of preprocessing;

FIG. 7 schematically shows a subdivision of the preprocessed signals into sections;

FIG. 8 illustrates an extraction of feature vectors from the sections;

FIG. 9 illustrates an exemplary transformation of the feature vectors into a statistical feature space;

FIG. 10 illustrates an exemplary transformation of the feature space of the statistical features into a one-dimensional representation; and

FIG. 11 illustrates exemplary clusters generated based on the one-dimensional representation of the statistical features.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

According to a first exemplary aspect, a method for processing signals comprises the steps:
sequencing the signals into sections;
determining at least one statistical feature for each of the sections; and
clustering the signals based on the determined statistical features.

According to another exemplary aspect, a computer program contains instructions that, while being executed by a computer, cause the computer to execute the following steps for processing signals:
sequencing the signals into sections;
determining at least one statistical feature for each of the sections; and
clustering the signals based on the determined statistical features.

The term “computer” is to be interpreted broadly. The term “computer” also encompasses microcontrollers, embedded systems, and other processor-based data processing devices.

The computer program may for example be made available for electronic retrieval or stored on a computer-readable memory medium.

According to another exemplary aspect, a device for processing signals has:
a sequencing circuit for sequencing the signals into sections;
an analytical circuit for determining at least one statistical feature for each of the sections; and
a clustering circuit for clustering the signals based on the determined statistical features.

In some embodiments, the database consists of measurements in a very high resolution, for example data from a CAN bus in the automotive sector. The mere clustering of the time series of the signals does not yield any useful results. There are numerous reasons for this. On the one hand, the signals may have different resolutions, which is why a direct comparison is not possible even if the signals are very similar, such as for example for the front right wheel speed and the front left wheel speed. Moreover, the signals may be so highly dynamic that they cannot be assigned to a common cluster in the high-resolution depiction of the algorithm even though to a person, they very obviously correspond to the same clusters. Finally, clustering the original time series may be so memory-intensive that it is only possible in sequences, for example in sections with a duration of 10 minutes in each case. Experiments with such sections have however yielded poor results.

In some embodiments, the database is divided into small sequences. The sequences may for example have a duration of 10 minutes or also hours. Statistical features of these sequences are calculated, i.e., statistical, artificial characteristic values are aggregated from the time intervals. These features serve as initial data for a cluster algorithm. The results are clustered signals. These clusters can be used as an initial basis for other processing steps. In some embodiments, a refined database is used as the database in which the initial data are equidistant and have the same length.

Since only simple mathematical operations are needed, the cluster algorithm may for example be implemented during signal acquisition, for example in a motor vehicle. This enables data-efficient storage and makes it possible to execute the following analysis by means of a cloud application in a data saving manner.

In some embodiments, a feature space for the determined statistical features is transformed into a lower dimensional space before clustering. In some embodiments, a transformation into a one-dimensional representation is performed. A high-quality data compression for signal description results from the transformation into a lower dimensional space. The resulting reduced database is particularly beneficial for the correct identification of the same signals in the available signal space since it facilitates machine processing of the data and supports error-free signal assignment.

In some embodiments, a principal component analysis is applied to the determined statistical features for transforming the feature space, or at least one determined statistical feature is selected. The principal component analysis, also known as a principal axis transformation, is ideally suitable for structuring comprehensive data sets in that the available statistical variables are approximated by a reduced number of meaningful primary components. Alternatively, it is possible to use only one determined statistical feature, or a reduced selection of statistical features, such as the average of certain time periods. Suitable results can also be achieved with this approach. The statistical features that are best suitable for a specific application can be determined empirically. In some embodiments, the selection may be adapted to the statistical features during operation.

In some embodiments, the at least one statistical feature is an average, a maximum value, a minimum value or a quantile. The quantile may for example be a quartile, i.e., the quantiles Q_{0.25}, Q_{0.5} and Q_{0.75}, also termed a lower quartile, middle quartile and upper quartile. All of these statistical features are highly suitable for a subsequent formation of clusters. Of course, a selection or subset of statistical features may also be determined.

In some embodiments, a density-based clustering method, a partitioning clustering method or a hierarchical clustering method is used for clustering the signals. For example, a DBSCAN algorithm may be used as the density-based clustering method. The use of a K-means algorithm lends itself as a partitioning clustering method. Examples of suitable hierarchical clustering methods are agglomerative clustering or a mean shift algorithm. The benefit of using hierarchical clustering methods is that no prior knowledge of the number of clusters is needed. Moreover, the form of the clusters is not restricted. In some embodiments, silhouette coefficients are used to ascertain the quality of clustering.

In some embodiments, a signal is determined as a representative of each cluster resulting from clustering. By determining one signal per cluster as a representative, the data volume that for example must be provided to a cloud-based application for an analysis can be significantly reduced.

In some embodiments, at least the signals determined as representatives are supplied to a predictive algorithm. The predictive algorithm may for example be configured to calculate aging in a data-driven matter. In some embodiments, all signals are also taken into account that were not assigned to a cluster. As a consequence of the restriction to the signals determined as representatives and possibly the unclustered signals, the effect of redundant signals is eliminated when determining results for e.g. an artificial neural network, and optimized results can therefore be anticipated.

In some embodiments, clusters for identifying a faulty sensor that result from clustering are used. Based on an error-free clustering of the same sensor information, the detection of faulty sensors is enabled since those defective or changed signals, or respectively sensors that were not assigned to the correct cluster, can be identified. This yields overarching quality assurance that ensures the informative value of the available signals. The assumption in this case is that a cluster must always find the same participants in error-free operation. Should significant deviations be found, for example because a signal is missing or another signal is added, it may be an indication of a faulty sensor.

A method according to the teachings herein or a device according to the teachings herein may be used in a (semi)autonomously or manually controlled means of conveyance. The means of conveyance may be for example a motor vehicle, a ship, or an aircraft such as for example a helicopter, a VTOL aircraft, fixed-wing aircraft, without limitation. Moreover, the solution according to the teachings herein may also be used in industrial machines such as in production machines or test benches.

In order to better understand the principles of the present invention, further embodiments are discussed in greater detail below based on the FIGS. It should be understood that the invention is not limited to these embodiments and that the features described may also be combined or modified without departing from the scope as defined in the appended claims.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

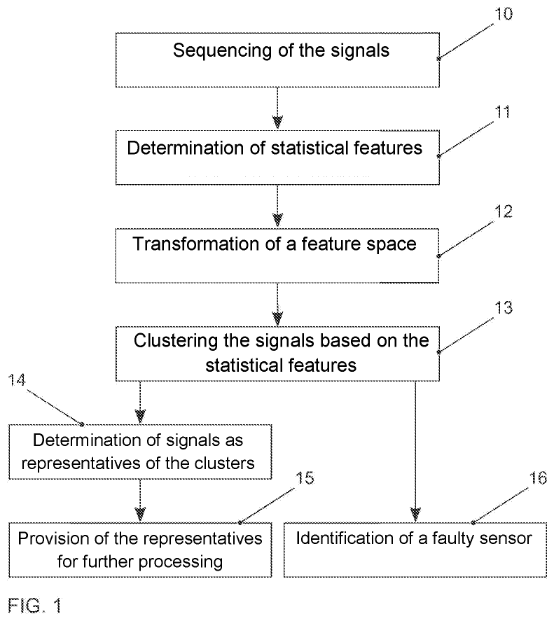

FIG. 1 schematically shows a method for processing signals, for example sensor signals, modeled variables or manipulated variables. In a first step, the signals are sequenced 10 into sections. For each of the sections, then at least one statistical feature is determined 11 such as an average, a maximum value, a minimum value or a quantile. Then a feature space of the determined statistical features can optionally be first transformed 12 into a lower dimensional space. To accomplish this, for example a principal component analysis can be applied to the statistical features, or at least one determined statistical feature can be selected. The signals are clustered 13 based on the determined statistical features. To accomplish this, a density-based clustering method, a partitioning clustering method or a hierarchical clustering method may for example be used. For each of the clusters resulting from the clustering 13, a signal is then determined 14 as a representative. At least the signals determined as representatives are finally provided for further processing 15. For example, the signals determined as representatives can be supplied to a predictive algorithm. The predictive algorithm can for example be configured to calculate aging in a data-driven matter. In some embodiments, all signals are also taken into account that were not assigned to a cluster. Alternatively, clusters for identifying a faulty sensor 16 that result from clustering can be used.

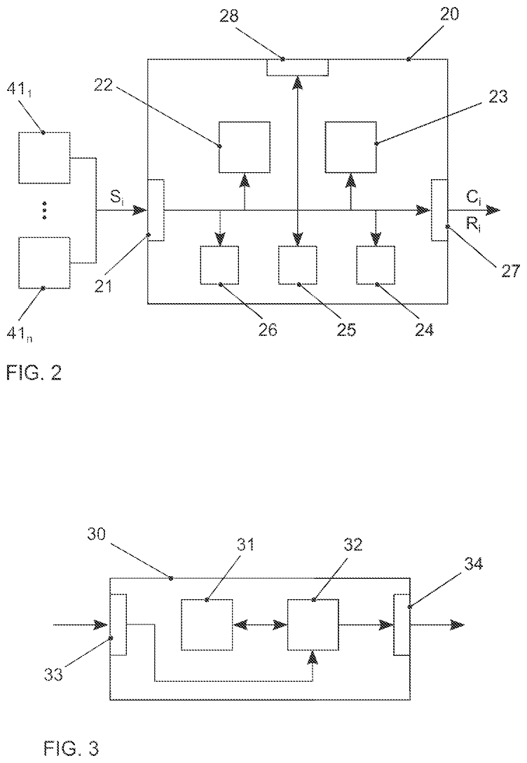

FIG. 2 shows a simplified schematic representation of a first embodiment of a device 20 for processing signals, for example sensor signals, modeled variables or manipulated variables. The device 20 has an input 21 by which the signals Sᵢ from different sensors 41ᵢ can be received, of which two are shown as an example. A sequencing module 22 is configured to sequence the signals Sᵢ into sections. An analytical module 23 determines at least one statistical feature such as an average, a maximum value, a minimum value or a quantile for each of the sections. After determining the features, the analytical module 23 can optionally be configured to transform a feature space of the statistical features into a lower dimensional space, for example by applying a principal component analysis to the statistical features, or by selecting at least one determined statistical feature. Based on the determined statistical features, a clustering module 24 then clusters the signals Sᵢ. To accomplish this, a density-based clustering method, a partitioning clustering method or a hierarchical clustering method can for example be used. The clustering module 24 is moreover configured to determine a signal Sᵢ as a representative Rᵢ for each cluster resulting from clustering. At least the signals Sᵢ determined as representatives Rᵢ are lastly provided for further processing through an output 27 of the device 20. For example, the signals determined as representatives can be supplied to a predictive algorithm, or used to identify a faulty sensor. The predictive algorithm can for example be configured to calculate aging in a data-driven matter. In some embodiments, all signals Sᵢ are also taken into account that were not assigned to a cluster. Alternatively, the clusters Cᵢ that result from clustering can be output and used for identifying a faulty sensor.

The sequencing module 22, the analytical module 23 and the clustering module 24 can be controlled by a control module 25. If applicable, settings of the sequencing module 22, the analytical module 23, the clustering module 24 or the control module 25 can be changed by means of a user interface 27. The data accumulating in the device 20 can be filed in a memory 26 of the device 20 if required, for example for later evaluation or for use by the components of the device 20. The sequencing module 22, the analytical module 23, the clustering module 24 and the control module 25 can be realized as dedicated hardware, such as integrated circuits. Of course, they can, however, also be partially or completely combined or implemented as software that runs on a suitable processor, such as a GPU or CPU. The input 21 and output can be implemented as separate interfaces or as a combined bidirectional interface.

FIG. 3 shows a simplified schematic representation of a second embodiment of a device 30 for processing signals. The device 30 comprises a processor 32 and a memory 31. For example, the device 30 is a microcontroller or an embedded system. Instructions are saved in the memory 31 that, when executed by the processor 32, cause the device 30 to execute the steps according to one of the described methods. The instructions saved in the memory 31 thus represent a program that can be run by the processor 32 and that is realized by the method as discussed herein. The device 30 has an input 33 for receiving information, in particular from signals. Data generated by the processor 32 are made available via an output 34. Moreover, said data can be saved in the memory 31. The input and the output 34 can be combined into a bidirectional interface.

The processor 32 may comprise one or more processor units, for example microprocessors, digital signal processors or combinations thereof.

The memories 26, 31 of the described embodiments can have volatile as well as non-volatile memory sections and can comprise a wide range of memory units and storage media, such as hard disks, optical storage media or semiconductor memories.

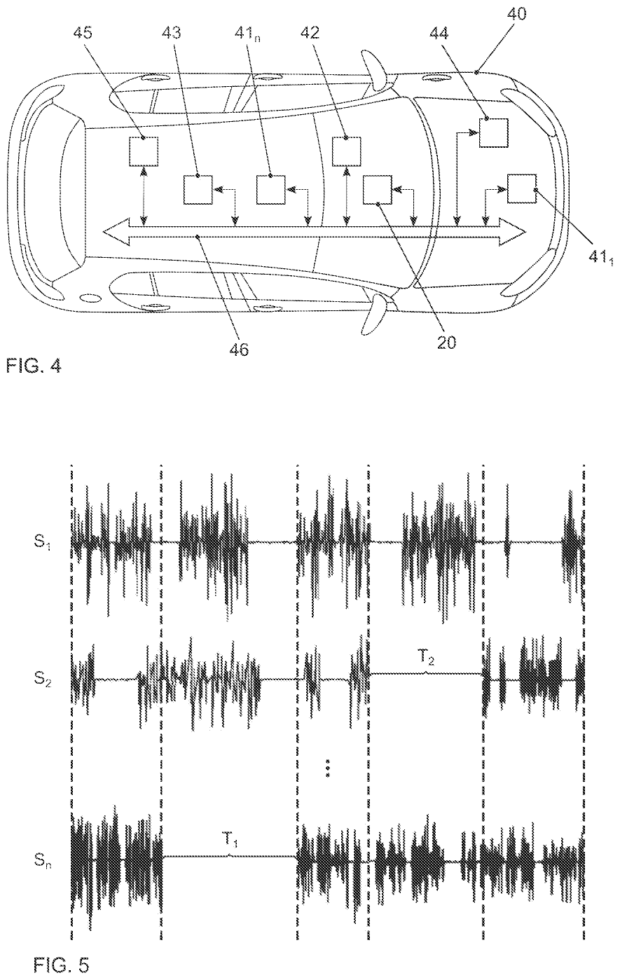

Another embodiment is described in detail below with reference to FIG. 4 to FIG. 11. In this embodiment, signals from a means of conveyance are considered. Of course, the discussed solution is not restricted to this application. It may inter alia also be used in industrial machines such as in production machines or test benches.

FIG. 4 schematically shows a means of conveyance 40 in which a solution according to the teachings herein is realized. The means of conveyance 40 in this example is a motor vehicle. The motor vehicle has a plurality of sensors 41ᵢ, of which some are shown as examples, and from which sensor signals relating to a series of components of the motor vehicle can be provided. Moreover, the motor vehicle has a device 20 according to the teachings herein for processing the signals. Other components of the motor vehicle are a navigation system 42, a data transmission unit 43 and a series of assistance systems 44, one of which is shown here by way of example. By means of the data transmission unit 43, for example a connection to service providers can be established such as to further process the signals. A memory 45 is provided for storing data. The data are exchanged between the various components of the motor vehicle via a network 46, for example via a CAN bus.

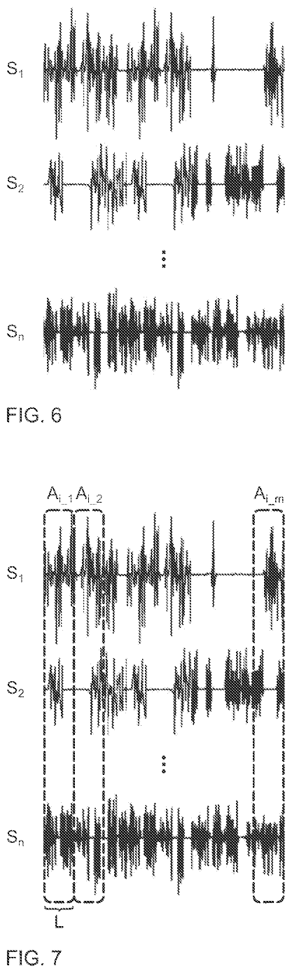

FIG. 5 schematically shows a series of signals Sᵢ that are to be subjected to preprocessing. There are n signals Sᵢ, of which for example three signals Sᵢ, S₂, Sₙ are shown. The signals can for example be sensor signals, modeled variables or manipulated variables. The signals Sᵢ may for example be transmitted on the CAN bus of a motor vehicle. Gaps, or respectively time periods Tᵢ occur in the signals Sᵢ in which there are no useful data. These time periods Tᵢ may for example be removed from all the signals Sᵢ in the context of preprocessing, i.e., the corresponding time periods Tᵢ are cut out of the signals Sᵢ. The signals Sᵢ after the conclusion of pre-processing are shown in FIG. 6.

FIG. 7 schematically shows a subdivision of the preprocessed signals Sᵢ into sections A_{i_n}. In the shown example, the signals Sᵢ are divided into m sections A_{i_n}, each of the same length L. Based on these sections A_{i_n}, a time series interpretation is performed in which a feature vector is extracted for each signal Sᵢ for each of the sections A_{i_n}.

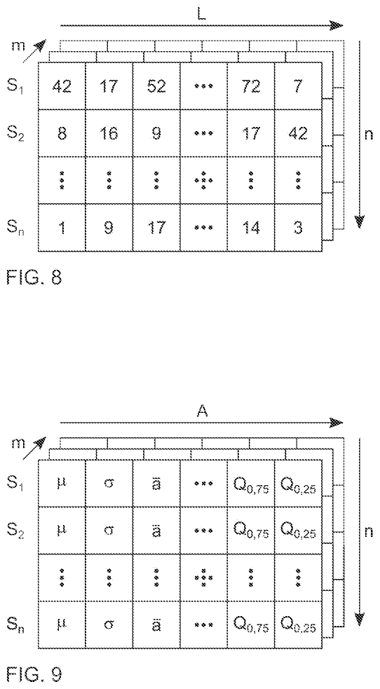

FIG. 8 illustrates the extraction of feature vectors from the sections A_{i_n}. After the extraction, there are m arrays with features. The dimensions of the m arrays are determined on the one hand by the number n of the signals, and on the other hand by the length L of the individual signal sections A_{i_n}. Statistical features are then determined on the basis of the individual feature vectors. The length L of the individual signal sections A_{i_n} can for example be determined empirically. Evaluations have shown that an aggregation of around one hour achieves positive results in determining aging that arises over a time of use of several hundred hours.

FIG. 9 illustrates a transformation of the feature vectors into a statistical feature space. After the determination of the statistical features, there are m arrays with statistical features. The dimensions of the m arrays are on the one hand also determined by the number n of signals, but they are on the other hand determined by the number A of the statistical features determined for each feature vector. If it is assumed that high-resolution time series within a vehicle have a frequency resolution of 10 Hz, and if these time series are pooled into one hour with the assistance of a statistical feature, the amount of data from 1×60×60×10=36000 measured values is reduced to a single value.

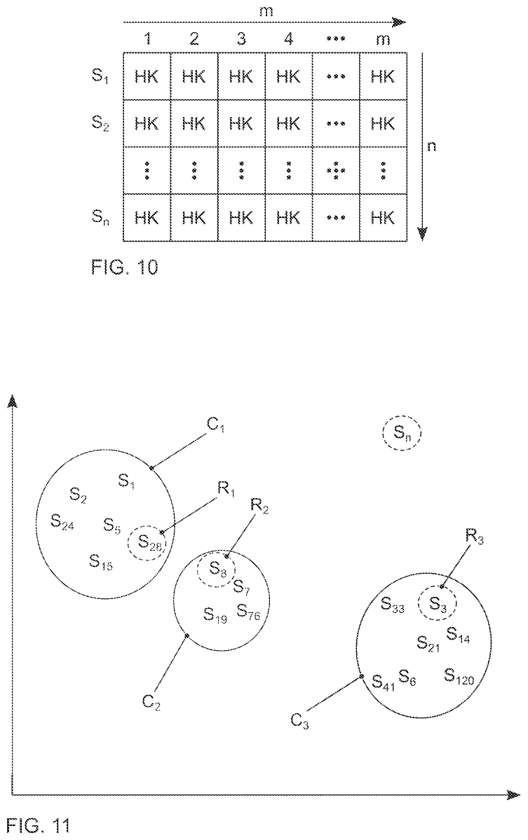

FIG. 10 illustrates a transformation of the feature space of the statistical features into a one-dimensional representation. For this purpose, the statistical features are subjected to a principal component analysis. In this example, only one individual principal component HK is retained. Following the principal component analysis, a single array exists with principal components HK. The dimensions of the array are on the one hand also determined by the number n of signals, and on the other hand by the number m of sections. This array serves as the basis for a cluster algorithm.

FIG. 11 illustrates clusters Cᵢ generated based on the one-dimensional representation of the statistical features. In the shown example, three clusters C₁, C₂, C₃ are discernible. Each cluster Cᵢ includes a plurality of signals Sᵢ. In addition, a signal Sₙ exists that is not assigned to any cluster Cᵢ. From each cluster Cᵢ, a signal Sᵢ can be selected as a representative Rᵢ. This can for example be the first found participant of the particular cluster Cᵢ, or the participant that lies closest to the midpoint of the cluster Cᵢ within the cluster Cᵢ. The representatives Rᵢ as well as the signal Sₙ not assigned to any cluster Cᵢ finally yield the resulting signal quantity indicated by the dashed ellipses. The clustering is for example repeated regularly during operation since faulty sensors or outliers can be thereby identified. Clustering can however also be performed once in order to thus identify a clustered signal quantity. This makes it possible to only consider unique signals, i.e., to exclude signals Sᵢ that include the same information as the unique signal.

The first cluster C₁ can for example include the following signals Sᵢ:

S₁: Front left wheel speed

S₂: Front right wheel speed

S₂₄: Rear left wheel speed

S₁₅: Rear right wheel speed

S₅: Wheel speed

S₂₈: Vehicle speed

The signal S₂₈, i.e., the speed of the vehicle, serves in this case as a representative R₁ of the first cluster C₁.

The second cluster C₂ can for example include the following signals Sᵢ:

S₇: Calculated gear

S₈: Gear

S₇₆: Target gear

S₁₉: Gear 2

The signal S₈, i.e., the gear, serves in this case as a representative R₂ of the second cluster C₂.

The third cluster C₃ can for example include the following signals Sᵢ:

S₃: Time 1

S₃₃: Time 2

S₂₁: Time 3

S₁₄: Time 4

S₁₂₀: Time 5

S₆: Time 6

S₄₁: Time 7

The signal S₃, i.e., a first time signal, serves in this case as a representative R₃ of the third cluster C₃.

Other clusters can for example result from signals that indicate a position of the pedal and an engine performance, or from signals that indicate an oil temperature and a coolant temperature.

### LIST OF REFERENCE NUMERALS

10 Sequencing of the signals

11 Determination of statistical features

12 Transformation of a feature space

13 Clustering the signals based on the statistical features

14 Determination of signals as representatives of the clusters

15 Provision of the representatives for further processing

16 Identification of a faulty sensor

20 Device

21 Input

22 Sequencing circuit

23 Analytical circuit

24 Cluster circuit

25 Control circuit

26 Memory

27 Output

28 User interface

30 Device

31 Memory

32 Processor

33 Input

34 Output

40 Means of conveyance

41ᵢ Sensor

42 Navigation system

43 Data transmission unit

44 Assistance system

45 Memory

46 Network

A Number of determined statistical features

A_{i_n} Section

Cᵢ Cluster

HK Primary component

L Length of the sections

m Number of sections

n Number of signals

Rᵢ Representative

Sᵢ Signal

Tᵢ Time period

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for processing signals having the steps:
sequencing the signals into sections;
determining at least one statistical feature for each of the sections; and
clustering the signals based on the determined statistical features.

2. The method of claim 1, wherein a feature space of the at least one determined statistical feature is transformed into a lower dimensional space before clustering.

3. The method of claim 2, wherein a principal component analysis is applied to the at least one determined statistical feature for transforming the feature space, or at least one determined statistical feature is selected.

4. The method of claim 1, wherein the at least one statistical feature is an average, a maximum value, a minimum value, or a quantile.

5. The method of claim 1, wherein a density-based clustering method, a partitioning clustering method, or a hierarchical clustering method is used for clustering the signals.

6. The method of claim 1, wherein a signal is determined as a representative for each cluster resulting from clustering.

7. The method of claim 6, wherein at least the signals determined as representatives are supplied to a predictive algorithm.

8. The method of claim 7, wherein the predictive algorithm calculates aging in a data-driven manner.

9. The method of claim 1, wherein the clusters that result from clustering are used for identifying a faulty sensor.

10. A non-transitory medium having instructions that, when being executed by a computer, cause the computer to conduct the steps of the method of claim 1.

11. A device for processing signals, comprising:
a sequencer for sequencing the signals into sections;
an analytical circuit for determining at least one statistical feature for each of the sections; and
a clustering circuit for clustering the signals based on the determined statistical features.

12. A means of conveyance, wherein the means of conveyance has a device of claim 11.

13. An industrial machine, wherein the industrial machine has a device of claim 11.

14. The method of claim 2, wherein the at least one statistical feature is an average, a maximum value, a minimum value, or a quantile.

15. The method of claim 3, wherein the at least one statistical feature is an average, a maximum value, a minimum value, or a quantile.

16. The method of claim 2, wherein a density-based clustering method, a partitioning clustering method, or a hierarchical clustering method is used for clustering the signals.

17. The method of claim 3, wherein a density-based clustering method, a partitioning clustering method, or a hierarchical clustering method is used for clustering the signals.

18. The method of claim 4, wherein a density-based clustering method, a partitioning clustering method, or a hierarchical clustering method is used for clustering the signals.

19. A means of conveyance, wherein the means of conveyance is configured to execute the method claim 1.

20. An industrial machine, wherein the industrial is configured to execute the method of claim 1.
